(19) United States
(12) Patent Application Publication
(10) Pub. No.: US 2007/0114294 A1
(43) Pub. Date: May 24, 2007

(54) Apparatus for remotely controlling the environment of multiple animal cages

(76) Inventor: Ralph A. Ashton JR., Mulberry, FL (US)

Correspondence Address: ADVANTIA LAW GROUP, 9035 SOUTH 1300 EAST, SUITE 200, SANDY, UT, 84094, US

(21) Appl. No.: 11/283,092

(22) Filed: Nov. 18, 2005

(51) Int. Cl. G05D 23/00

(52) U.S. Cl. 236/51

(57) ABSTRACT

A novel apparatus for remotely controlling the local environment of an animal cage at least includes: a housing unit; a display carried by the housing unit adapted to display animal cage environment information; an input device carried by the housing unit adapted to receive user input signals; a plurality of sensor inputs for receiving environment condition sensor information from environmental condition sensors; a power input carried by the housing unit; a controller subsumed by the housing unit; and a plurality of power receptacles carried by the housing, the power receptacles adapted to supply power to remotely located environment altering devices in a manner dictated by user input. The apparatus is adapted to control the local animal cage environment of a plurality of animal cages.

### BACKGROUND OF THE INVENTION

1. Field of the Invention

The present invention generally relates to control of the environments experienced by caged animals.

2. Description of the Related Art

Retaining animals in cages by pet owners or zoos often entails exposing the animals to environments which differ from their natural habitats. The environmental factors include aspects such as temperature, humidity, sunlight and light in general, and others. When the cage environments are significantly different from those of the natural habitats, many animals cannot adequately adjust to the conditions. This can lead to inordinate sickness, shortened life spans, and even rapid morbidity. For example, an animal used to higher temperatures might fare poorly in a low temperature environment. As another example, an animal used to a low humidity environment might fare poorly in a high humidity environment.

To address these problems, some prior art approaches have attempted to control the local environments of animal cages by placing heating devices, cooling devices, humidifiers, dehumidifiers, and lighting devices in or near the cages. One approach attempts remote control by allowing a user to input environment data such as temperature into a remote controller. The remote environment controller is connected to an electrical outlet/receptacle box which can then turn on or turn off power to devices such as a heater placed near an animal cage. This arrangement is bulky, requiring an undesirable number of cords and connectors. Further, the prior art animal cage remote control devices appear to control only one type of environmental aspect (e.g., temperature only; light only).

What is sorely needed but not present in the prior art is a remote animal cage environment control device, allowing a user to control multiple environmental aspects, in more than one animal cage, with power receptacles integrated into a single unit.

### SUMMARY OF THE INVENTION

The present invention has been developed in response to the present state of the art, and in particular, in response to the problems and needs in the art that have not yet been fully solved. Accordingly, the present invention has been developed to provide a novel apparatus for remotely controlling the local environment of an animal cage. The apparatus at least includes: a housing unit; a display carried by said housing unit adapted to display animal cage environment information; an input device carried by said housing unit adapted to receive user input signals; a plurality of sensor inputs for receiving environment condition sensor information from environmental condition sensors; a power input carried by said housing unit; a controller subsumed by said housing unit; and a plurality of power receptacles carried by said housing, said power receptacles adapted to supply power to remotely located environment altering devices in a manner dictated by user input. The apparatus is adapted to control the local animal cage environment of a plurality of animal cages.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front view of the present-inventive remote animal cage environment controller; and

FIG. 2 is a schematic block diagram of the present-inventive remote animal cage environment controller.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

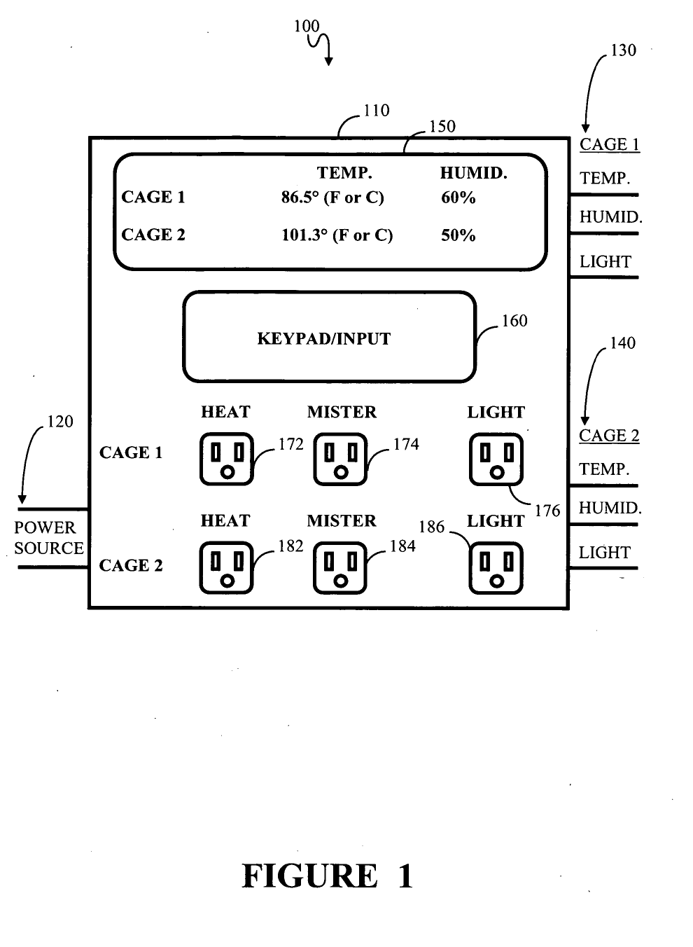

FIG. 1 illustrates the present-inventive apparatus 100 for remotely controlling the environment in two animal cages (not shown). Given the teachings now revealed below and in the Summary section supra, those skilled in the art to which the present invention pertains will appreciate that the apparatus 100 can be modified to control more than two animal cages.

A single housing 110 contains the apparatus components. AC power is introduced to the apparatus via the port 120. There are also inputs for sensors located in or near each animal cage. In the illustration, information from temperature, humidity and light sensors in or near a first animal cage is received at the inputs 130, while information from temperature, humidity and light sensors in or near a second animal cage is received at the inputs 140.

A display 150 displays environment information regarding each environmentally controlled animal cage, as well as program information resulting from a user's input via the keypad/input 160. In the preferred embodiment separate power receptacles exists to power animal cage heating devices (via 172 and 182), misting devices (via 174 and 184), and lighting devices (via 176 and 186). The user can program for each animal cage, the temperature, humidity and lighting times or conditions. The apparatus 100 then regulates the power to heating, misting (or humidifying), and lighting devices to activate and deactivate the aforementioned devices in order to maintain the animal cage environments close to programmed (by a user) conditions.

In addition to heating, misting and lighting devices, the apparatus 100 can also control cooling devices, dehumidifying devices and others. The lighting devices can be of the incandescent variety, ultraviolet variety, and other varieties.

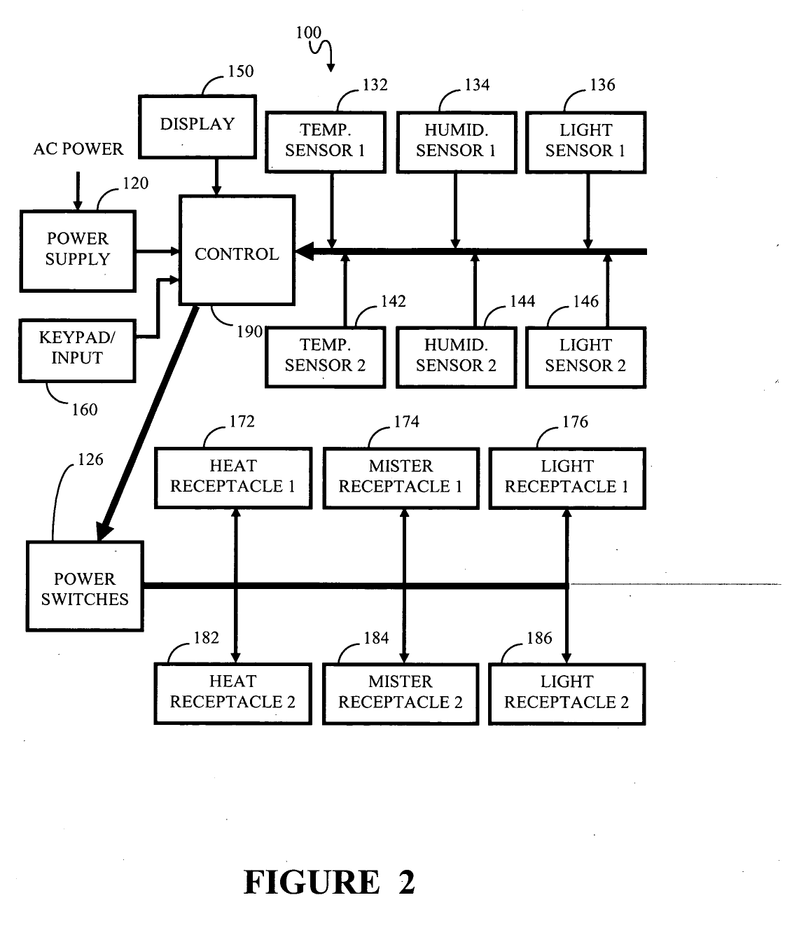

A schematic block diagram of the apparatus 100 is shown in FIG. 2. In addition to the components previously discussed, the apparatus 100 has a microprocessor based control unit 190. Power to the receptacles 172-186 is controlled by switching 126 under the direction of the control unit. The animal cage environmental sensors are schematically represented by the numbers 132, 134, 136, 142, 144 and 146.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An apparatus for remotely controlling the local environment of an animal cage, said apparatus comprising:
a housing unit;
a display carried by said housing unit adapted to display animal cage environment information;
an input device carried by said housing unit adapted to receive user input signals;
a plurality of sensor inputs for receiving environment condition sensor information from environmental condition sensors;
a power input carried by said housing unit;
a controller subsumed by said housing unit; and
a plurality of power receptacles carried by said housing, said power receptacles adapted to supply power to remotely located environment altering devices in a manner dictated by user input;
wherein said apparatus is adapted to control the local animal cage environment of a plurality of animal cages.

2. The apparatus of claim 1, wherein said environmental sensor information relates to temperature.

3. The apparatus of claim 1, wherein said environmental sensor information relates to humidity.

4. The apparatus of claim 1, wherein said environmental sensor information relates to light.

5. The apparatus of claim 1, wherein said power receptacles are adapted to control the power to heating devices.

6. The apparatus of claim 1, wherein said power receptacles are adapted to control the power to humidity increasing devices.

7. The apparatus of claim 1, wherein said power receptacles are adapted to control the power to lighting devices.

8. The apparatus of claim 1, wherein said power receptacles are adapted to control the power to cooling devices.

9. The apparatus of claim 1, wherein said power receptacles are adapted to control the power to humidity decreasing devices.

10. The apparatus of claim 1, wherein said environmental sensor information relates to temperature, humidity and light, and wherein said power receptacles are adapted to control the power to heating devices, humidity increasing devices, and lighting devices.

11. An apparatus for remotely controlling the local environment of an animal cage, said apparatus consisting of:
a housing unit;
a display carried by said housing unit adapted to display animal cage environment information;
an input device carried by said housing unit adapted to receive user input signals;
a plurality of sensor inputs for receiving environment condition sensor information from environmental condition sensors;
a power input carried by said housing unit;
a controller subsumed by said housing unit; and
a plurality of power receptacles carried by said housing, said power receptacles adapted to supply power to remotely located environment altering devices in a manner dictated by user input;
wherein said apparatus is adapted to control the local animal cage environment of a plurality of animal cages.

12. The apparatus of claim 11, wherein said environmental sensor information relates to temperature.

13. The apparatus of claim 11, wherein said environmental sensor information relates to humidity.

14. The apparatus of claim 11, wherein said environmental sensor information relates to light.

15. The apparatus of claim 11, wherein said power receptacles are adapted to control the power to heating devices.

16. The apparatus of claim 11, wherein said power receptacles are adapted to control the power to humidity increasing devices.

17. The apparatus of claim 11, wherein said power receptacles are adapted to control the power to lighting devices.

18. The apparatus of claim 11, wherein said power receptacles are adapted to control the power to cooling devices.

19. The apparatus of claim 11, wherein said power receptacles are adapted to control the power to humidity decreasing devices.

20. The apparatus of claim 11, wherein said environmental sensor information relates to temperature, humidity and light, and wherein said power receptacles are adapted to control the power to heating devices, humidity increasing devices, and lighting devices.
